(19) United States
(12) Patent Application Publication
(10) Pub. No.: US 2005/0027909 A1
(43) Pub. Date: Feb. 3, 2005

(54) USB Interfaced vehicle phonographic equipment

(76) Inventor: Han-Mei Liu Kan, Taipei City (TW)

Correspondence Address: SUPREME PATENT SERVICES, POST OFFICE BOX 2339, SARATOGA, CA, 95070, US

(21) Appl. No.: 10/655,962

(22) Filed: Sep. 4, 2003

(30) Foreign Application Priority Data
Jul. 29, 2003 (TW) 092213785

(51) Int. Cl. G06F 13/10

(52) U.S. Cl. 710/62

(57) ABSTRACT

A USB interfaced vehicle phonographic equipment has one end opening for penetratingly disposing a USB interface jack, and also has a circuit board arranged in the casing of the main body thereof. The circuit board has a USB interface control unit having one end electrically connected with the USB interface jack, so that data transmitting or power securing is possible after a USB device has been plugged in that jack.

### BACKGROUND OF THE INVENTION

1. Field of the Invention

The present invention relates to vehicle phonographic equipments, and more particularly, it relates to a vehicle phonographic equipment provided with a USB interface jack disposed at one end opening in the main body thereof, so that data transmitting or power securing is possible.

2. The Prior Arts

When reviewing back the industry progress in human history, the invention of steam engine by James Watt (1736-1819), which is generally referred as the first industry revolution, has driven the automobile industry to advance for at least 100 years to result in today's booming of the industry. Then, computer, which has changed people's daily life for the following decades, is undoubtedly considered the star shinning the most in the second industry revolution to convert our life from an analog era into a digital era. In the third industry revolution, which is also referred as the web revolution, people have started to learn for exchanging data on-line from computer to computer, however, integration is so far still needed to unite a computer and an automobile.

In the real life, people are always longing for an automobile with more new functions and with effective connection to a computer via, for example, a USB (universal serial bus) interface, so that it becomes possible for people to download MP3 music through the USB interface and play the music by a portable on-car player. More than this, it is also possible for people to detect internal state of an automobile and store the data in a USB interfaced memory device, then transmit the same to an automobile maintenance center for computer diagnosis. Besides, a driver can operate a cellular phone through a USB interface and uses automobile phonographic equipment for a hand-free talk for promoting traffic security. After all, there is no difficult at all for people to match or communicate an automobile, as long as it is offered with automobile phonographic equipment having a USB interface, with any product available in market equipped with a USB interface.

In many cases, the cigarette lighting jack is considered the most convenient power source for on-car electronic devices. However, this power source is found defective in the following respects:

(1) As the cigarette lighting jack always continues supplying power even after engine is stopped, dangers may be thus caused in the duration when the driver leaves away for a while.

(2) As the cigarette lighting jack always continues supplying power even after engine is stopped, an electronic device connected with the jack keeps on consuming power of the battery and as a consequence, making the battery gradually run out of power.

The cigarette lighting jack is more or less unsightly and a little bit too far from the dashboard to use.

For improving the defects, we have here a secure 5V power source provided by automobile phonographic equipment to therefore by-pass the power given by the cigarette lighting jack.

### SUMMARY OF THE INVENTION

The present invention discloses a USB interfaced vehicle phonographic equipment, which is capable of securing power through any USB interfaced current information product, such as a PDA, a cellular phone, a USB interfaced video recorder, or a USB interfaced HDD, and fetching data or music songs.

Therefore, the primary object of the present invention is to provide a USB interfaced vehicle phonographic equipment capable of securing power through a USB interfaced information product.

Another object of the present invention is to provide a USB interfaced vehicle phonographic equipment having a USB jack for plugging to connect with a portable USB interfaced product, such as a cellular phone, a PDA, a portable MP3 player, etc., for fetching diagram files, films, written data, and music songs.

For more detailed information regarding advantages or features of the present invention, at least an example of preferred embodiment will be described below with reference to the annexed drawings.

### BRIEF DESCRIPTION OF THE DRAWINGS

The related drawings in connection with the detailed description of the present invention to be made later are described briefly as follows, in which:

FIG. 1 is a perspective view of a USB interfaced vehicle phonographic equipment of the present invention; and

FIG. 2 shows a block diagram of a circuit of the USB interfaced vehicle phonographic equipment of the present invention.

### DETAILED DESCRIPTION OF THE PREFERRED EMBODIMENT

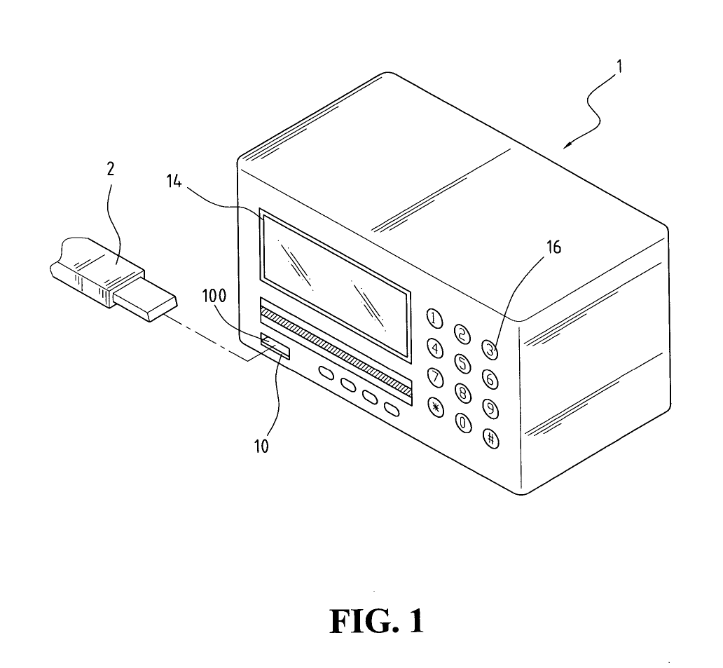

With reference to the drawings and in particular to FIG. 1, a USB interfaced vehicle phonographic equipment of the present invention comprises a main body of phonographic equipment 1 having at least two end openings 10, one of which is provided for penetratingly disposing a USB interface jack 100, so that a USB device 2 is insertable and thus fixed for data transmission of diagram files, films, written data, music songs, and the likes, or for power input. The USB device 2 can be an MP3 player, a portable data storage device (a pocket disk for example), a cellular phone, or a PDA (personal digital assistant).

On a central upper portion of the front face of the main body of phonographic equipment 1, a liquid-crystal displayer 14 is located for showing necessary information to a user, and a plurality of pushbuttons 16 on the right portion of the front face of the main body of phonographic equipment 1 is provided for the user to input commands for changing the operation mode of the present invention.

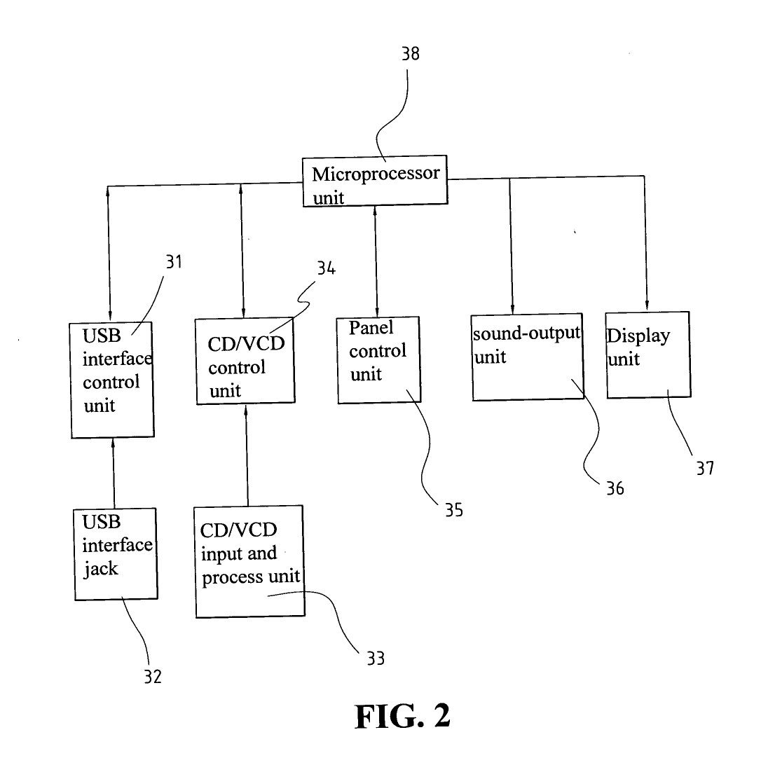

Also referring to FIG. 2, the casing of the main body of phonographic equipment 1 is united with an inside circuit board (not shown). The circuit board comprises a USB interface control unit 31, a CD/VCD input and process unit 33, a CD/VCD control unit 34, a panel control unit 35, a sound-output unit 36, a display unit 37, and a microprocessor unit 38.

The USB interface control unit 31 has one end electrically connected with a USB interface jack 32 so as to facilitate the insertion of the USB device 2 for performing data transmission of diagram files, films, written data, music songs, and the likes, or for power input. In this case, the chip M5271 with code M5271, A0, 0214 TS05, XK6035770BTA of a local company Ali is adopted.

The CD/VCD input and process unit 33 could be a CD/VCD read/write head for reading data on a CD/VCD, including diagram files, films, written data, or music songs.

The CD/VCD control unit 34 could be a DVD player chipset or a CD-R/RW chipset—24/12/48 CD-R/RW chipset, which is electrically connected with the CD/VCD input and process unit 33 or controlling reading action of the latter. In this case, the chip M5705A1, 0130 TH05, XHAQ96000NOE of Ali is adopted.

The panel control unit 35 comprises a plurality of pushbuttons for a user to input commands to change the operation mode.

The sound-output unit 36 could be a speaker for playing music or warning.

The display unit 37 could be a liquid crystal display for showing data of the present operation.

The microprocessor unit 38 could be a 32-bit microprocessor connected with the USB interface control unit 31, the CD/VCD control unit 34, the panel control unit 35, the sound-output unit 36, and the display unit 37, respectively, for control of different actions. In this case, a processor chip arm920T under Thumb extension framework of Arm Co. is adopted.

In the above described, at least one preferred embodiment has been described in detail with reference to the drawings annexed, and it is apparent that numerous changes or modifications may be made without departing from the true spirit and scope thereof, as set forth in the claims below.

1. A USB interfaced vehicle phonographic equipment, comprising:
a main body having at least two end openings, of which a first one end opening is provided for penetratingly disposing a USB interface jack, and disposed in a casing of the main body in which a circuit board is arranged
a USB interface control unit, of which one end is electrically connected with the USB interface jack for selectivley controlling a plugged USB device in transmission of diagram files, films, written data, and selectively fetching power.

2. The vehicle phonographic equipment according to claim 1, wherein the USB device is a pocket disk.

3. The vehicle phonographic equipment according to claim 2, wherein the USB device is a cellular phone.
